(19) United States
(12) Patent Application Publication
(10) Pub. No.: US 2009/0152155 A1
(43) Pub. Date: Jun. 18, 2009

(54) Cold-Formable Laminate for Blister Base Parts

(76) Inventor: Erwin Pasbrig, Singen (DE)

Correspondence Address: FISHER, CHRISTEN & SABOL, 1120 20TH STREET, NW, SOUTH TOWER, SUITE 750, WASHINGTON, DC, 20036, US

(21) Appl. No.: 12/085,180

(22) PCT Filed: Oct. 17, 2006
(86) PCT No.: PCT/EP2006/009984

§ 371 Date: May 19, 2008

(30) Foreign Application Priority Data
Nov. 17, 2005 (EP) 05405644.5

(51) Int. Cl. B65D 83/04; B32B 15/08

(52) U.S. Cl. 206/531; 428/461; 428/337; 428/458; 428/336; 428/341

(57) ABSTRACT

A cold-formable laminate (10) made of an aluminum foil (14) which is laminated on both sides with plastics material for producing base parts of blister packagings for products which are sensitive to moisture and oxygen, has a plastics material layer arranged on a first side of the aluminum foil (14), as the outer layer (12), and has a sealing layer (16) arranged on the second side of the aluminum foil (14) made of a film or a coating made of polyvinylidene chloride (PVDC). The laminate is suitable for the production of base parts of blister packagings for products which are sensitive to moisture and oxygen.

The invention relates to a cold-formable laminate made of an aluminium foil which is laminated on both sides with plastics material for producing base parts of blister packagings for products which are sensitive to moisture and oxygen, with a plastics material layer arranged on a first side of the aluminium foil, as the outer layer, and a sealing layer arranged on the second side of the aluminium foil.

Cold-formable laminates made of an aluminium foil which are laminated on both sides with plastics material are used inter alia for producing base parts of blister packagings for pharmaceutical products. Wells for receiving individual tablets or other forms of individual doses are formed in the base parts. The aluminium foil is used here primarily as a barrier layer against the penetration of water vapour and gases and protects the products above all from absorbing or giving off moisture.

Conventional laminates for producing base parts of blister packagings for pharmaceutical products frequently have the structure oPA/aluminium foil/sealing layer. Conventional sealing layers consist of 15 to 100 μm PVC, 20-60 μm PP or 30-50 μm PE. After filling the wells, an optionally peelable outer foil is sealed against the base part. Conventional outer foils are optionally aluminium foils which are optionally coated with plastics material, laminated with film or lacquered. In these blister packagings, the products are protected against environmental influences from both sides between two aluminium foils which are arranged as a barrier against the penetration of water vapour and gases.

A blister packaging, however, has unprotected points. After being punched out, the cut edges are exposed and in the case of perforation, the perforation cuts are exposed. The sealing layer is no longer protected at these points by the barrier layer made of aluminium. Over time, moisture and gases diffuse by means of lateral diffusion through the plastics material into the wells and thus shorten the durability of the filling.

More and more active ingredients for medicines and chemicals for diagnostic applications are being developed which have a very high sensitivity to moisture and oxygen. For products of this type blister packagings with reduced lateral diffusion would be desirable.

Multi-layer films with a barrier layer and with a sealing layer containing material which absorbs moisture are known from WO-A-2004/000541 and WO-A-2004/080808. The films are used for the packaging of items which are sensitive to moisture and oxygen, such as, for example, diagnostic test strips, and are either hot-sealed after folding against themselves or against a second film. Calcium oxide (CaO) is preferably used as the moisture-absorbing material with strong water binding.

The invention is based on the object of providing a cold-formable laminate of the type mentioned at the outset which is suitable for producing base parts of blister packagings for products which are sensitive to moisture and oxygen, said laminate having a higher protective effect against the penetration of moisture and oxygen in the case of lateral diffusion than conventional laminates according to the prior art even without the admixing of materials which absorb moisture to the sealing layer.

The fact that the sealing layer consists of a film or of a coating made of polyvinylidene chloride (PVDC) leads to the achievement of the object according to the invention.

The outer layer is preferably a biaxially stretched film made of plastics material.

A first laminate structure according to the invention has the layer sequence outer layer/aluminium foil/sealing layer.

In a second laminate structure according to the invention with the layer sequence outer layer/intermediate layer/aluminium foil/sealing layer, a further preferably biaxially stretched film made of plastics material is arranged, as the intermediate layer, between the outer layer and the aluminium foil.

In a third laminate structure according to the invention with the layer sequence outer layer/aluminium foil/intermediate layer/sealing layer, a further preferably biaxially stretched film made of plastics material is arranged as the intermediate layer between the sealing layer and the aluminium foil.

In a fourth laminate structure according to the invention with the layer sequence outer layer/intermediate layer/aluminium foil/intermediate layer/sealing layer, a further, preferably biaxially stretched film made of plastics material is arranged, in each case, as the intermediate layer, both between the outer layer and the aluminium foil and between the sealing layer and the aluminium foil.

The aluminium foil is in the soft state and preferably has a thickness of 20 to 100 μm, in particular 30 to 60 μm.

The biaxially stretched films made of plastics material preferably have a thickness of 10 to 40 μm, in particular 12 to 40 μm.

The biaxially stretched films may consist of polypropylene (PP), polyester, polyvinylchloride (PVC), polyamide (PA), cycloolefin copolymer (COC) or cycloolefin polymer (COP).

The film made of polyvinylidene chloride (PVDC) may be unstretched or stretched and preferably has a thickness of 5 to 110 μm, preferably 10 to 60 μm. The ideal film thickness with regard to an optimal barrier effect, in particular against the lateral diffusion of oxygen, is 5 to 19 μm, in particular 10 to 19 μm. Conventional commercial materials may be used such as IXAN®, DIOFAN®, SARAN@, SARANEX® or SUMINLITE®.

A coating with polyvinylidene chloride (PVDC) takes place with an aqueous solution or with resin dissolved in organic solvent. The application weight is preferably 5 to 120 g/m², in particular 10 to 60 g/m². The ideal application weight with regard to an optimal barrier effect, in particular against the lateral diffusion of oxygen, is 20 to 30 g/m².

The individual layers may be connected by lamination with solvent-based, solvent-free or aqueous adhesives and/or by extrusion lamination. The outer layer or the aluminium foil which is located therebelow may be printed.

A blister base part may be produced in the known manner from the cold-formable laminate. The sealing layer of the laminate in this case forms the inner layer of the blister base part.

In a blister packaging for products which are sensitive to moisture and oxygen, in particular for pharmaceutical products such as tablets and powders which are sensitive to moisture and oxygen, an aluminium foil which is optionally coated with plastics material and/or with other materials, laminated with film or lacquered, is sealed against the PVDC layer of the blister base part in a known manner.

Preferred film/foil combinations for the four laminate structures according to the invention are compiled in Tables 1 to 4.

The abbreviations for the plastics materials used as a base for the films signify:

oPA oriented polyamide PET polyethyleneterephthalate
OPP oriented polypropylene PVDC polyvinylidene chloride

TABLE 1
First laminate structure

| No. | Outer layer | Al | Sealing layer |
|---|---|---|---|
| 1 | 25 μm oPA | Al 45 | 10 μm PVDC |
| 2 | 25 μm oPA | Al 60 | 10 μm PVDC |
| 3 | 25 μm oPA | Al 45 | 20 g/m² PVDC |
| 4 | 25 μm oPA | Al 60 | 20 g/m² PVDC |
| 5 | 25 μm oPA | Al 45 | 15 μm PVDC |
| 6 | 25 μm oPA | Al 60 | 15 μm PVDC |
| 7 | 25 μm oPA | Al 45 | 19 μm PVDC |
| 8 | 25 μm oPA | Al 60 | 19 μm PVDC |
| 9 | 25 μm oPA | Al 45 | 25 μm PVDC |
| 10 | 25 μm oPA | Al 60 | 25 μm PVDC |
| 11 | 25 μm oPA | Al 45 | 60 g/m² PVDC |
| 12 | 25 μm oPA | Al 60 | 60 g/m² PVDC |
| 13 | 25 μm oPA | Al 45 | 38 μm PVDC |
| 14 | 25 μm oPA | Al 60 | 38 μm PVDC |
| 15 | 23 μm PET | Al 45 | 38 μm PVDC |
| 16 | 23 μm PET | Al 45 | 25 μm PVDC |
| 17 | 23 μm PET | Al 45 | 40 g/m² PVDC |
| 18 | 20 μm oPP | Al 45 | 38 μm PVDC |
| 19 | 20 μm oPP | Al 45 | 25 μm PVDC |
| 20 | 20 μm oPP | Al 45 | 38 μm PVDC |

TABLE 2
Second laminate structure

| No. | Outer layer | Al | Intermediate layer | Sealing layer |
|---|---|---|---|---|
| 21 | 25 μm oPA | Al 45 | 25 μm oPA | 10 μm PVDC |
| 22 | 25 μm oPA | Al 60 | 25 μm oPA | 13 μm PVDC |
| 23 | 25 μm oPA | Al 45 | 25 μm oPA | 25 μm PVDC |
| 24 | 25 μm oPA | Al 60 | 25 μm oPA | 25 μm PVDC |
| 25 | 25 μm oPA | Al 45 | 25 μm oPA | 20 g/m² PVDC |
| 26 | 25 μm oPA | Al 60 | 25 μm oPA | 10 μm PVDC |
| 27 | 25 μm oPA | Al 45 | 25 μm oPA | 25 μm PVDC |
| 28 | 25 μm oPA | Al 60 | 25 μm oPA | 38 μm PVDC |
| 29 | 25 μm oPA | Al 45 | 15 μm oPA | 13 μm PVDC |
| 30 | 25 μm oPA | Al 60 | 15 μm oPA | 38 μm PVDC |
| 31 | 23 μm PET | Al 60 | 25 μm oPA | 15 μm PVDC |
| 32 | 23 μm PET | Al 60 | 25 μm oPA | 19 μm PVDC |
| 33 | 23 μm PET | Al 60 | 25 μm oPA | 15 μm PVDC |
| 34 | 23 μm PET | Al 45 | 25 μm oPA | 19 μm PVDC |
| 35 | 23 μm PET | Al 60 | 25 μm oPA | 25 μm PVDC |
| 36 | 23 μm PET | Al 45 | 15 μm oPA | 38 μm PVDC |
| 37 | 23 μm PET | Al 60 | 15 μm oPA | 40 g/m² PVDC |
| 38 | 20 μm oPP | Al 60 | 25 μm oPA | 13 μm PVDC |
| 39 | 20 μm oPP | Al 60 | 25 μm oPA | 10 μm PVDC |
| 40 | 20 μm oPP | Al 60 | 25 μm oPA | 13 μm PVDC |
| 41 | 20 μm oPP | Al 45 | 25 μm oPA | 25 μm PVDC |
| 42 | 20 μm oPP | Al 60 | 25 μm oPA | 20 g/m² PVDC |
| 43 | 20 μm oPP | Al 45 | 15 μm oPA | 25 μm PVDC |
| 44 | 20 μm oPP | Al 60 | 15 μm oPA | 19 μm PVDC |

TABLE 3
Third laminate structure

| No. | Outer layer | Intermediate layer | Al | Sealing Layer |
|---|---|---|---|---|
| 45 | 20 μm oPA | 20 μm oPA | Al 45 | 10 μm PVDC |
| 46 | 15 μm oPA | 15 μm oPA | Al 60 | 10 μm PVDC |
| 47 | 20 μm oPA | 20 μm oPA | Al 45 | 15 μm PVDC |
| 48 | 15 μm oPA | 15 μm oPA | Al 60 | 15 μm PVDC |
| 49 | 20 μm oPA | 20 μm oPA | Al 45 | 40 g/m² PVDC |
| 50 | 15 μm oPA | 15 μm oPA | Al 60 | 40 g/m² PVDC |
| 51 | 20 μm oPA | 20 μm oPA | Al 45 | 19 μm PVDC |
| 52 | 15 μm oPA | 15 μm oPA | Al 60 | 19 μm PVDC |

TABLE 4
Fourth laminate structure

| No. | Outer layer | Intermediate layer | Al | Intermediate layer | Sealing layer |
|---|---|---|---|---|---|
| 53 | 20 μm oPA | 20 μm oPA | Al 45 μm | 15 μm oPA | 15 μm PVDC |
| 54 | 15 μm oPA | 15 μm oPA | Al 60 μm | 15 μm oPA | 19 μm PVDC |
| 55 | 20 μm oPA | 20 μm oPA | Al 45 μm | 15 μm oPA | 13 μm PVDC |
| 56 | 15 μm oPA | 15 μm oPA | Al 60 μm | 15 μm oPA | 13 μm PVDC |
| 57 | 20 μm oPA | 20 μm oPA | Al 45 μm | 15 μm oPA | 20 g/m² PVDC |
| 58 | 15 μm oPA | 15 μm oPA | Al 60 μm | 15 μm oPA | 19 μm PVDC |

Further advantages, features and details of the invention emerge from the following description of preferred embodiments and with the aid of the drawings, in which, schematically:

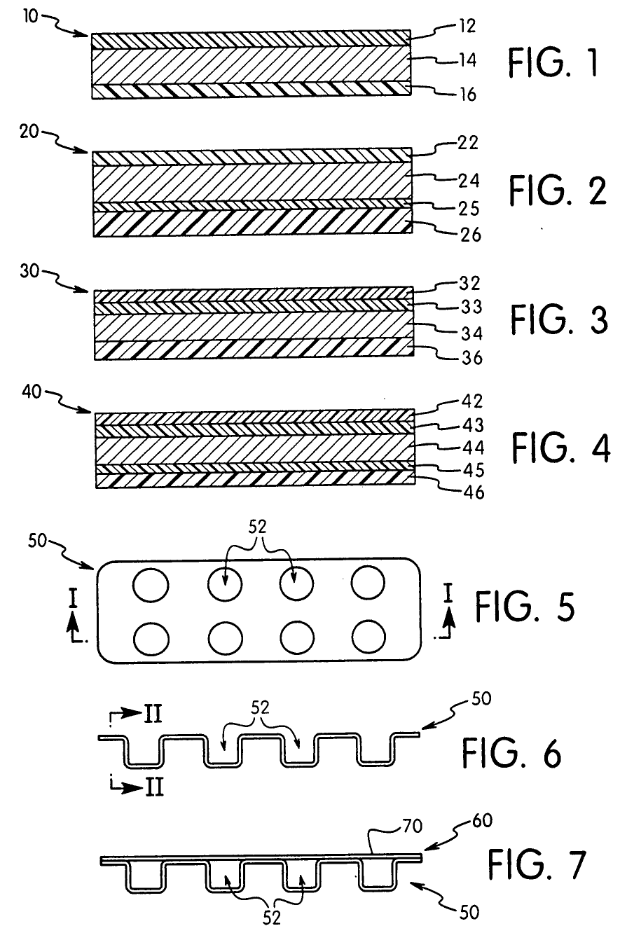

FIG. 1 shows the layer structure of a first cold-formable laminate for the production of blister base parts according to FIG. 5, corresponding to the section line II-II of FIG. 6;

FIG. 2 shows the layer structure of a second cold-formable laminate for the production of blister base parts according to FIG. 5, corresponding to the section line II-II of FIG. 6;

FIG. 3 shows the layer structure of a third cold-formable laminate for the production of blister base parts according to FIG. 5, corresponding to the section line II-II of FIG. 6;

FIG. 4 shows the layer structure of a fourth cold-formable laminate for the production of blister base parts according to FIG. 5, corresponding to the section line II-II of FIG. 6;

FIG. 5 shows the plan view of a blister base part cold-formed from one of the laminates of FIG. 1 to 4;

FIG. 6 shows the section through the blister base part of FIG. 5 along the line I-I;

FIG. 7 shows the blister base part of FIG. 5 with the sealed-on press-through foil or a peelable outer foil.

A first cold-formable laminate 10 for producing base parts for blister packagings for products which are sensitive to moisture and oxygen, according to FIG. 1, has the following layer structure:
12 outer layer, for example oPA, 25 μm
14 aluminium foil, for example 60 μm
16 sealing layer of PVDC, for example 10 μm or 20 g/m²

The oPA film 12 forms the later outer side and the sealing layer 16 the inner side of a blister base part produced from the laminate 10.

A second cold-formable laminate 20 for producing base parts for blister packagings for products which are sensitive to moisture and oxygen, according to FIG. 2, has the following layer structure:
22 outer layer, for example PET, 23 μm
24 aluminium foil, for example 60 μm
25 intermediate layer, for example oPA, 15 μm
26 sealing layer of PVDC, for example 30 μm or 40 g/m²

The PET film 22 forms the later outer side and the sealing layer 26 the inner side of a blister base part produced from the laminate 20.

A third cold-formable laminate 30 for producing base parts for blister packagings for products which are sensitive to moisture and oxygen, according to FIG. 3, has the following layer structure:
32 outer layer, for example oPA, 20 μm
33 intermediate layer, for example oPA, 20 μm
34 aluminium foil, for example 45 μm
36 sealing layer of PVDC, for example 19 μm or 40 g/m²

The oPA film 32 forms the later outer side and the sealing layer 36 the inner side of a blister base part produced from the laminate 30.

A fourth cold-formable laminate 40 for producing base parts for blister packagings for products which are sensitive to moisture and oxygen, according to FIG. 4, has the following layer structure:
42 outer layer, for example oPA, 20 μm
43 intermediate layer, for example oPA, 20 μm
44 aluminium foil, for example 45 μm
45 intermediate layer, for example oPA, 15 μm
46 sealing layer of PVDC, for example 13 μm or 20 g/m²

The oPA film 42 forms the later outer side and the sealing layer 46 the inner side of a blister base part produced from the laminate 40.

A blister base part 50 shown in FIG. 5 is produced from the laminate 10, 20, 30, 40, the wells 52 formed from the laminate being formed from the laminate to receive, for example, tablets, by means of cold forming, such as, for example, by deep drawing by means of a die and mould, a two-stage method with dies and a mould or die/compressed air and mould.

As shown in FIGS. 6 and 7, after the filling of the wells 52, a press-through or peelable outer foil 70 is sealed onto the base 50 to form a blister packaging 60, as required.

An outer foil 70 designed as a press-through foil for a blister base part 50 produced from the laminate 10, 20, 30, 40 has, for example, the following layer structure: sealing layer/aluminium foil/print undercoat lacquer/printing/print top lacquer. The printing with the print top lacquer forms the later outer side of the outer foil 70, the free side of the aluminium foil is sealed against the sealing layer of PVDC of a blister base part 50 produced from the laminate.

An outer foil 70 configured as a peelable foil for a blister base part 50 produced from the laminate 10, 20, 30, 40 has, for example, the following layer structure: sealing medium/aluminium foil/adhesive layer/film made of polyethyleneterephthalate (PET)/adhesive layer/paper/printing/print top lacquer. The printing with the print top lacquer forms the later outer side of the outer foil 70 and the free side of the aluminium foil is sealed against the sealing layer made of PVDC of a blister base part 50 produced from the laminate.

1. A cold-formable laminate (10, 20, 30, 40) made of an aluminum foil (14, 24, 34, 44) which is laminated on both sides with plastics material for producing base parts (50) of blister packagings (60) for products which are sensitive to moisture and oxygen, with a plastics material layer arranged on a first side of the aluminum foil (14, 24, 34, 44) as an outer layer (12, 22, 32, 42) and a sealing layer (16, 26, 36, 46) arranged on the second side of the aluminum foil (14, 24, 34, 44), the sealing layer (16, 26, 36, 46) consists of a film or of a coating made of polyvinylidene chloride (PVDC).

2. The cold-formable laminate (10, 20, 30, 40) according to claim 1, wherein the outer layer (12, 22, 32, 42) is a biaxially stretched film made of plastics material.

3. The cold-formable laminate (30, 40) according to claim 2, wherein a biaxially stretched film made of plastics material as an intermediate layer (33, 43) is arranged between the outer layer (32, 42) and the aluminum foil (34, 44).

4. The cold-formable laminate (20, 40) according to claim 1, wherein a biaxially stretched film made of plastics material as the intermediate layer (25, 45) is arranged between the aluminum foil (24, 44) and the film or the coating (26, 46) made of polyvinylidene chloride (PVDC).

5. The cold-formable laminate (10, 20, 30, 40) according to claim 1, wherein the aluminum foil (14, 24, 34, 44) has a thickness of 20 to 100 μm.

6. The cold-formable laminate (10, 20, 30, 40) according to claim 2, wherein the biaxially stretched films made of plastics material have a thickness of 10 to 40 μm.

7. The cold-formable laminate (10, 20, 30, 40) according to claim 2, wherein the biaxially stretched films are made of polypropylene (PP), polyester, polyvinylchloride (PVC), polyamide (PA), cycloolefin copolymer (COC), or cycloolefin polymer (COP).

8. The cold-formable laminate (10, 20, 30, 40) according to claim 2, wherein the film (16, 26, 36, 46) made of polyvinylidene chloride (PVDC) is unstretched or stretched and has a thickness of 10 to 120 μm.

9. The cold-formable laminate (10, 20, 30, 40) according to claim 1, wherein the film (16, 26, 36, 46) made of polyvinylidene chloride (PVDC) is unstretched or stretched and has a thickness of 5 to 19 μm.

10. The cold-formable laminate (10, 20, 30, 40) according to claim 1, wherein the coating (16, 26, 36, 46) made of polyvinylidene chloride (PVDC) has an application weight of 5 to 120 g/m².

11. The cold-formable laminate (10, 20, 30, 40) according to claim 1, wherein the coating (16, 26 36, 46) made of polyvinylidene chloride (PVDC) has an application weight of 20 to 30 g/m².

12. A blister base part (50) produced from a cold-formable laminate (10, 20, 30, 40) according to claim 1.

13. A blister packaging (60) for products which are sensitive to moisture and oxygen, with a blister base part (50) produced from a cold-formable laminate (10, 20, 30, 40) according to claim 1 and an outer foil (70) which is sealed against the sealing layer (16, 26, 36, 46) of the laminate on the blister base part (50) and contains an aluminum foil.

14. A process of utilizing the blister packaging (60) according to claim 13 for pharmaceutical products, such as tablets and powders which are sensitive to moisture and oxygen.

15. The cold-formable laminate (20, 40) according to claim 3, wherein a biaxially stretched film made of plastics material as the intermediate layer (25, 45) is arranged between the aluminum foil (24, 44) and the film or the coating (26, 46) made of polyvinylidene chloride (PVDC).

16. The cold-formable laminate (10, 20, 30, 40) according to claim 15, wherein the aluminum foil (14, 24, 34, 44) has a thickness of 30 to 60 μm.

17. The cold-formable laminate (10, 20, 30, 40) according to claim 15, wherein the biaxially stretched films made of plastics material have a thickness of 12 to 40 μm.

18. The cold-formable laminate (10, 20, 30, 40) according to claim 15, wherein the biaxially stretched films are made of polypropylene (PP), polyester, polyvinylchloride (PVC), polyamide (PA), cycloolefin copolymer (COC), or cycloolefin polymer (COP).

19. The cold-formable laminate (10, 20, 30, 40) according to claim 18, wherein the film (16, 26, 36, 46) made of polyvinylidene chloride (PVDC) is unstretched or stretched and has a thickness of 12 to 105 μm.

20. The cold-formable laminate (10, 20, 30, 40) according to claim 18, wherein the film (16, 26, 36, 46) made of polyvinylidene chloride (PVDC) is unstretched or stretched and has a thickness of 10 to 19 μm.

21. The cold-formable laminate (10, 20, 30, 40) according to claim 18, wherein the coating (16, 26, 36, 46) made of polyvinylidene chloride (PVDC) has an application weight of 10 to 60 g/m².

22. The cold-formable laminate (10, 20, 30, 40) according to claim 18, wherein the coating (16, 26 36, 46) made of polyvinylidene chloride (PVDC) has an application weight of 20 to 30 g/m².

23. The blister base part (50) produced from a cold-formable laminate (10, 20, 30, 40) according to claim 19.

24. The blister base part (50) produced from a cold-formable laminate (10, 20, 30, 40) according to claim 20.

25. The blister base part (50) produced from a cold-formable laminate (10, 20, 30, 40) according to claim 21.

26. The blister base part (50) produced from a cold-formable laminate (10, 20, 30, 40) according to claim 22.

27. The blister packaging (60) for products which are sensitive to moisture and oxygen, with a blister base part (50) produced from a cold-formable laminate (10, 20, 30, 40) according to claim 2 and an outer foil (70) which is sealed against the sealing layer (16, 26, 36, 46) of the laminate on the blister base part (50) and contains an aluminum foil.

28. The blister packaging (60) for products which are sensitive to moisture and oxygen, with a blister base part (50) produced from a cold-formable laminate (10, 20, 30, 40) according to claim 3 and an outer foil (70) which is sealed against the sealing layer (16, 26, 36, 46) of the laminate on the blister base part (50) and contains an aluminum foil.

29. The blister packaging (60) for products which are sensitive to moisture and oxygen, with a blister base part (50) produced from a cold-formable laminate (10, 20, 30, 40) according to claim 8 and an outer foil (70) which is sealed against the sealing layer (16, 26, 36, 46) of the laminate on the blister base part (50) and contains an aluminum foil.

30. The blister packaging (60) for products which are sensitive to moisture and oxygen, with a blister base part (50) produced from a cold-formable laminate (10, 20, 30, 40) according to claim 16 and an outer foil (70) which is sealed against the sealing layer (16, 26, 36, 46) of the laminate on the blister base part (50) and contains an aluminum foil.

31. The blister packaging (60) for products which are sensitive to moisture and oxygen, with a blister base part (50) produced from a cold-formable laminate (10, 20, 30, 40) according to claim 19 and an outer foil (70) which is sealed against the sealing layer (16, 26, 36, 46) of the laminate on the blister base part (50) and contains an aluminum foil.

32. The blister packaging (60) for products which are sensitive to moisture and oxygen, with a blister base part (50) produced from a cold-formable laminate (10, 20, 30, 40) according to claim 20 and an outer foil (70) which is sealed against the sealing layer (16, 26, 36, 46) of the laminate on the blister base part (50) and contains an aluminum foil.
